(19) United States
(12) Patent Application Publication
(10) Pub. No.: US 2025/0242887 A1
(43) Pub. Date: Jul. 31, 2025

(54) METHOD FOR CONTROLLING GEAR SHIFTING OF A BICYCLE AND BICYCLE

(71) Applicant: BRP-ROTAX GMBH & CO. KG, Gunskirchen (AT)

(72) Inventor: Steffen MEYER-SALFELD, Leonberg (DE)

(21) Appl. No.: 19/037,399

(22) Filed: Jan. 27, 2025

Related U.S. Application Data
(60) Provisional application No. 63/625,574, filed on Jan. 26, 2024.

(51) Int. Cl. B62M 9/122; B62M 6/55; B62M 6/90

(52) U.S. Cl. CPC B62M 9/122; B62M 6/55; B62M 6/90

(57) ABSTRACT

A method for controlling gear shifting of a bicycle includes disconnecting a driving engagement between a cogset of the bicycle and a rear wheel of the bicycle, driving a flexible drive member that engages the cogset and a drive sprocket of the bicycle, shifting a position of a derailleur of the bicycle for causing the flexible drive member to shift from one driven sprocket of the cogset to an other driven sprocket of the cogset, and after shifting the flexible drive member from the one driven sprocket of the cogset to the other driven sprocket of the cogset, connecting the driving engagement between the cogset and the rear wheel. A bicycle is also disclosed.

### CROSS-REFERENCE TO RELATED APPLICATION

The present application claims priority to U.S. Provisional Patent Application No. 63/625,574, filed Jan. 26, 2024 entitled “Method for Controlling Gear Shifting of a Bicycle and Bicycle”, which is incorporated by reference herein in its entirety.

### TECHNICAL FIELD

The present technology relates to methods for controlling gear shifting of bicycles, and bicycles having shiftable drive assemblies.

### BACKGROUND

Conventional bicycles have derailleurs which are operable to cause a chain to shift gears (i.e., shift from one sprocket of a cogset, sometimes also referred to as a cassette, to another sprocket of the cogset). For smooth gear shifting, the chain has to be in movement. For these conventional bicycles, movement of the chain about the cogset generally requires that the bicycles be propelled forward.

That is, conventional bicycles generally cannot gear shift while at a standstill and/or without the chain being in movement about the cogset while the bicycle is moving forward. This can be inconvenient. For example, starting from a standstill, biking at a high gear can be difficult. This problem is further exacerbated for heavy bicycles and/or bicycle hauling cargo.

Therefore, there is a desire for a method and a bicycle that can enable gear shifting without having to propel the bicycle forward.

### SUMMARY

It is an object of the present technology to ameliorate at least some of the inconveniences present in the prior art.

According to one aspect of the present technology, there is provided a method for controlling gear shifting of a bicycle. the method includes disconnecting a driving engagement between a cogset of the bicycle and a rear wheel of the bicycle, driving a flexible drive member that engages the cogset and a drive sprocket of the bicycle, shifting a position of a derailleur of the bicycle for causing the flexible drive member to shift from one driven sprocket of the cogset to an other driven sprocket of the cogset, and after shifting the flexible drive member from the one driven sprocket of the cogset to the other driven sprocket of the cogset, connecting the driving engagement between the cogset and the rear wheel.

In some embodiments, the method further includes that the bicycle is at a standstill prior to disconnecting the driving engagement.

In some embodiments, shifting the position of the derailleur is performed after driving the flexible member.

In some embodiments, disconnecting the driving engagement between the cogset and the rear wheel includes moving a clutch to a disengaged state, the clutch selectively coupling the cogset to the rear wheel, and connecting the driving engagement between the cogset and the rear wheel includes moving the clutch to an engaged state.

In some embodiments, disconnecting the driving engagement between the cogset and the rear wheel includes moving at least one pawl of a shaft of the rear wheel from a deployed configuration to a retracted configuration, and connecting the driving engagement between the cogset and the rear wheel includes moving the at least one pawl of the shaft of the rear wheel from the retracted configuration to the deployed configuration.

In some embodiments, moving the at least one pawl between the deployed configuration and the retracted configuration includes moving a cam between a first position, in which the cam is engaged and aligned with the at least one pawl, causing the at least one pawl to be in the deployed configuration, and a second position, in which the cam is disengaged and spaced from the at least one pawl, causing the at least one pawl to be in the retracted configuration.

In some embodiments, the first position is a first axial position, the second position is a second axial position, and moving the at least one pawl between the deployed configuration and the retracted configuration includes axially moving the cam between the first axial position and the second axial position.

In some embodiments, disconnecting the driving engagement between the cogset and the rear wheel includes actuating a clutch actuator.

In some embodiments, the method further includes, before connecting the driving engagement between the cogset and the rear wheel, determining that the flexible drive member has shifted from the one driven sprocket of the cogset to the other driven sprocket of the cogset.

In some embodiments, determining that the flexible drive member has shifted from the one driven sprocket of the cogset to the other driven sprocket of the cogset is determined via sensors.

In some embodiments, the method further includes after shifting the flexible drive member from the one driven sprocket of the cogset to the other driven sprocket of the cogset, and before connecting the driving engagement between the cogset and the rear wheel, stopping the driving of the flexible drive member.

In some embodiments, stopping the driving of the flexible drive member occurs after one of a predetermined elapsed time after shifting the position of the derailleur, and a predetermined number of rotations of the drive sprocket after shifting the position of the derailleur.

In some embodiments, driving the flexible drive member includes actuating a motor operatively connected to the drive sprocket.

In some embodiments, the method further includes detecting a torque applied on a pedal of the bicycle, and in response to the detected torque being greater than a predetermined value, preventing the disconnecting of the driving engagement between the cogset and the rear wheel.

In some embodiments, driving the flexible drive member includes turning pedals of the bicycle, the pedals being drivingly engaged to the drive sprocket.

According to another aspect of the present technology, there is provided a bicycle including a frame, a handlebar operatively connected to the frame, a front wheel operatively connected to the handlebar, a rear wheel operatively connected to the frame, and a drive assembly connected to the frame. The drive assembly includes a drive sprocket, crank arms operatively connected to the drive sprocket, a cogset operatively connected to the rear wheel, a clutch operatively connected between the cogset and the rear wheel and a clutch actuator operatively connected to the clutch, a flexible driving member engaging the drive sprocket and the cogset, and a derailleur operatively connected to the flexible driving member. The clutch is moveable between an engaged state, in which the clutch drivingly engages the cogset to the rear wheel, and a disengaged state, in which the clutch drivingly disengages the cogset from the rear wheel. The clutch actuator is selectively actuated for moving the clutch between the engaged state and the disengaged state.

In some embodiments, the bicycle further includes an electric motor operatively connected to the drive sprocket, and a battery pack connected to the frame and electrically connected to the electric motor.

In some embodiments, the rear wheel includes a hollow hub, and a shaft received in the hollow hub. The shaft is operatively connected to the cogset, and has at least one pawl moveable between a deployed configuration, in which the shaft is drivingly engaged with the hollow hub, and a retracted configuration, in which the shaft is drivingly disengaged from the hollow hub. The clutch includes a cam moveable between a first position and a second position. With the clutch in the engaged state, the cam is in the first position, in which the cam is engaged with the at least one pawl, which causes the at least one pawl to be in the deployed configuration. With the clutch in the disengaged state, the cam is in the second position, in which the cam is disengaged from the at least one pawl, which causes the at least one pawl to be in the retracted configuration.

In some embodiments, the flexible driving member is a chain.

In some embodiments, the bicycle further includes a controller in communication with the clutch actuator and the derailleur. The controller is configured to cause actuation of the clutch actuator for moving the clutch to the disengaged state, cause a shift of the position of the derailleur for causing the flexible drive member to shift from one driven sprocket of the cogset to an other driven sprocket of the cogset, and after causing the shift of the position of the derailleur, cause actuation of the clutch actuator for moving the clutch to the engaged state.

In some embodiments, the first position is a first axial position and the second position is a second axial position.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a vehicle and components in relation to the bicycle, with the bicycle steered straight-ahead and being at rest on flat, level ground.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of an electric bicycle according to an embodiment of the present technology;

FIG. 2 is a perspective view taken from a top, rear, left side of part of the electric bicycle of FIG. 1;

FIG. 3A is a cross-sectional view of part of a drive assembly of the electric bicycle of FIG. 1 taken through line 3A-3A of FIG. 1, with a clutch of the drive assembly being in an engaged state;

FIG. 3B is a close-up of a region of the clutch of the drive assembly of FIG. 3A, with the clutch of the drive assembly being in a disengaged state;

FIG. 4A is a cross-sectional view of a hollow hub, a shaft with pawls, and the clutch of the drive assembly of the electric bicycle of FIG. 1 taken through the line 4A-4A of FIG. 3A, with the clutch being in an engaged state, and the pawls being in a driving position;

FIG. 4B is a cross-sectional view of the hollow hub, the shaft with the pawls, and the clutch of the drive assembly of the electric bicycle of FIG. 1 taken through the line 4A-4A of FIG. 3A, with the clutch being in an engaged state, and the pawls being in a non-driving position;

FIG. 4C is a cross-sectional view of a hollow hub, a shaft, and the clutch of the drive assembly of the electric bicycle of FIG. 1 taken through the line 4C-4C of FIG. 3B, with the clutch being in a disengaged state; and

FIG. 5 is a flowchart illustrating a method for controlling gear shifting of the electric bicycle of FIG. 1.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, “having”, “containing”, “involving” and variations thereof herein, is meant to encompass the items listed thereafter as well as, optionally, additional items. In the following description, the same numerical references refer to similar elements.

The present technology will be described with reference to a pedal-assist bicycle 10 (pedelec) in which an electric motor assists the cyclist's pedal-power without the need to actuate a “throttle”. It is contemplated that aspects of the present technology could be applied to other types of electric bicycles, such as power-on-demand bicycles or combination pedelec/power-on-demand bicycles. It is also contemplated that certain aspects of the present technology could be used in other types of bicycles, including bicycles that do not have an electric motor and are only propelled via the pedals.

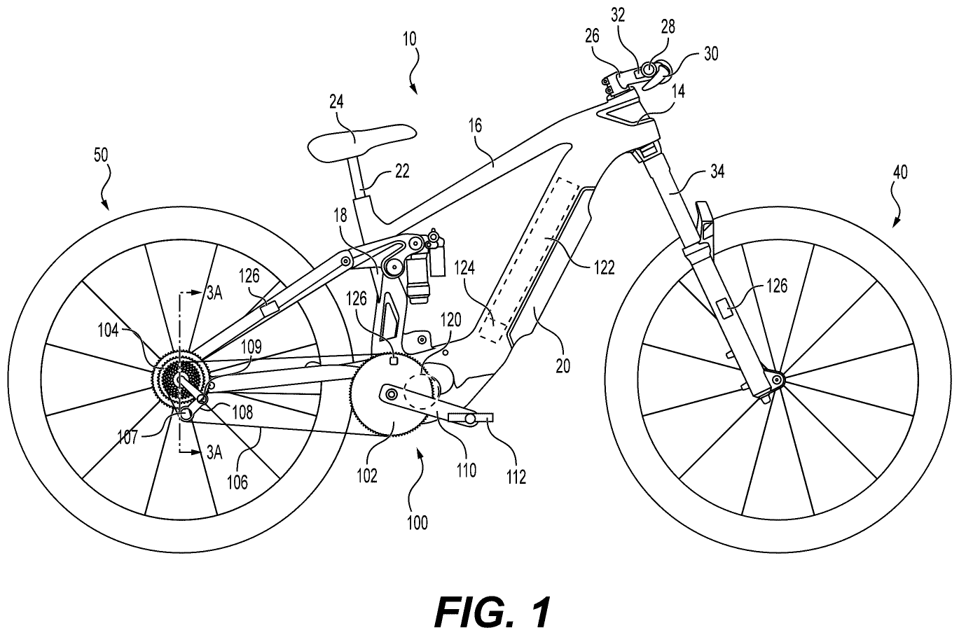

With reference to FIG. 1, the pedelec 10 has a frame 12. The frame 12 has a head tube 14, a top tube 16, a seat tube 18, and a down tube 20. As can be seen, the top tube 16, the seat tube 18 and the down tube 20 form a generally triangular shape. The seat tube 18 receives a seat post 22 therein. A saddle 24 is connected to a top of the seat post 22. The seat post 22 is selectively slidable in the seat tube 18 to adjust a height of the saddle 24. A clamp (not shown) is used to fix the seat post 22 in the desired position.

A handlebar 26 is pivotally connected to the head tube 14. The handlebar 26 has left and right hand grips 28 (only the right hand grip being shown in FIG. 1). Left and right brake levers 30 (only the right brake lever 30 being shown in FIG. 1) are mounted to the handlebar 26 in proximity to the left and right hand grips 28 respectively in front of the handlebar 26. A shifter 32 is pivotally connected to the handlebar 26 in proximity to the right hand grip 28. The shifter 32 extends partially rearward of the right hand grip 28. As such, the shifter 32 can be actuated by a thumb of a right hand of a cyclist riding the pedelec 10. It is contemplated that the shifter 32 could alternatively be provided in proximity to the left hand grip 28. In the present embodiment, the shifter 32 is used to upshift and downshift, but it is contemplated that the pedelec 10 could have one shifter to upshift and one shifter to downshift. These two shifters could be provided in proximity to the same hand grip 28 or there could be one shifter provided in proximity to each hand grip 28. It is also contemplated that in some embodiments, the shifter 32 could be replaced by a different type of shifter, such as a twistgrip.

Still referring to FIG. 1, a fork 34 is connected to the handlebar 26 below the head tube 14. A front wheel 40 is rotationally connected to the fork 34. The fork 34 and the front wheel 40 pivot with the handlebar 26 to steer the pedelec 10. The front wheel 40 has a threaded tire of the type typically found on mountain bikes, but other types of tires are contemplated. A front brake assembly (not shown) is mounted to the front wheel 40, and is operatively connected to one of the left and right brake levers 30.

A rear wheel 50 is rotationally connected to the frame 12. The rear wheel 50 has a threaded tire of the type typically found on mountain bikes, but other types of tires are contemplated. The rear wheel 50 will be described in greater detail below. A rear brake assembly (not shown) is mounted to the rear wheel 50 and is operatively connected to one of the left and right brake levers 30.

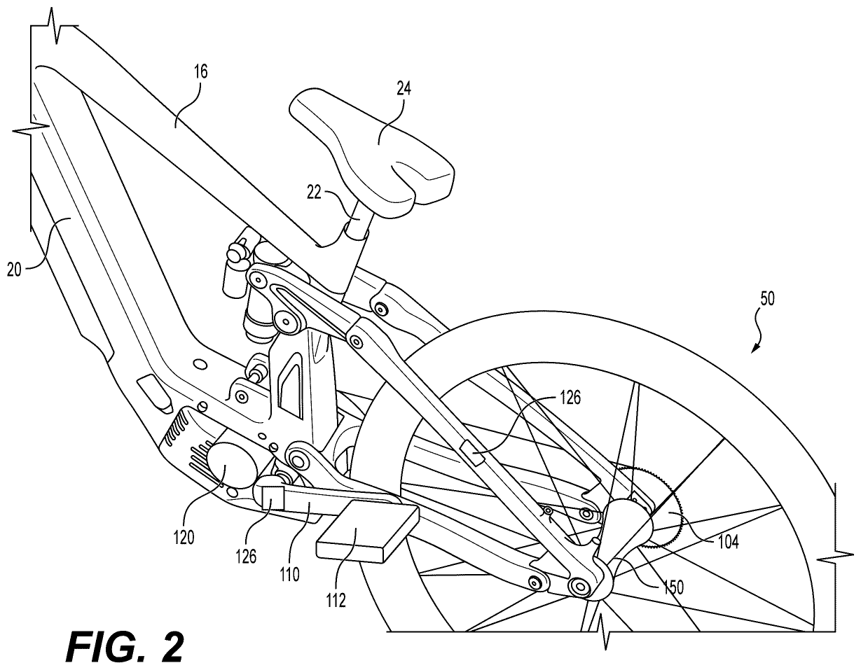

Referring to FIGS. 1 and 2, the pedelec 10 is propelled by a drive assembly 100. The drive assembly 100 includes a drive sprocket 102, a cogset 104, a flexible driving member 106 and a derailleur 108. It is contemplated that in some embodiments, the drive assembly could have more than one drive sprocket 102. In such embodiments, the drive assembly 100 would further be provided with a front derailleur for shifting between drive sprockets. The flexible driving member 106 is drivingly engaged to the drive sprocket 102 and the cogset 104. The flexible driving member 106 is also operatively connected to the derailleur 108.

The drive assembly 100 also includes crank arms 110 that are operatively connected to the drive sprocket 102. Pedals 112 are rotationally connected to the ends of the crank arms 110. The drive sprocket 102, the crank arms 110 and the pedals 112 are generally positioned so as to be easily engageable by feet of the cyclist riding the pedelec 10. The crank arms 110 are operatively connected to the drive sprocket 102 via a one-way freewheel clutch, such that rotating the crank arms 110 in a direction corresponding to propelling the pedelec 10 forward can drive the drive sprocket 102, but rotation of the drive sprocket 102 does not cause the crank arms 110 to rotate (i.e., the drive sprocket 102 can rotate faster than the crank arms 110). Additionally, rotating the crank arms 110 opposite to the direction corresponding to propelling the pedelec 10 forward does not drive the drive sprocket 102 in the backwards direction.

The drive assembly 100 also includes an electric motor 120 (schematically shown in FIG. 1). The electric motor 120 is supported by the frame 12, and is operatively connected to the drive sprocket 102. The electric motor 120 is configured to selectively drive the drive sprocket 102.

The electric motor 120 is electrically connected to a battery pack 122 (schematically shown in FIG. 1). The battery pack 122 is disposed in the down tube 20 of the frame 12 and connected to the frame 12. The battery pack 122 includes a battery tray holding a plurality of batteries as well as power and control electronics. The batteries are lithium-ion batteries such as Samsung™ 40T batteries. It is contemplated that the batteries could be of a different type, could be electrically connected in a variety of ways, and/or could be disposed in the frame differently. The power and control electronics include a controller 124 (schematically shown in FIG. 1), which can allow for wireless data communication, control the flow of power to and from the batteries, and control actuation of the electric motor 120. The power and control electronics also include sensors 126 (some of which are schematically shown in FIGS. 1 and 2) that are communicatively connected to the controller 124. The sensors 126 include a torque sensor for measuring the torque applied on the crank arms 110, a linear speed sensor for measuring linear velocity of the pedelec 10, rotational speed sensors for measuring rotational speeds of the front wheel 40, the rear wheel 50, the drive sprocket 102 and/or the cogset 104. Other sensors are contemplated as well.

The cogset 104, as will be described in greater detail below, is operatively connected to the rear wheel 50. The cogset 104 has seven sprockets: 131, 132, 133, 134, 135, 136, 137. It is contemplated that in other embodiments, the cogset 104 could have more or less than seven sprockets. Each of the seven sprockets 131, 132, 133, 134, 135, 136, 137 is different in diameter and has a different number of teeth from the other sprockets 131, 132, 133, 134, 135, 136, 137. The sprocket 131 has the smallest diameter, and thus the least number of teeth. The sprocket 137 has the largest diameter, and thus has the greatest number of teeth. Shifting the flexible drive member 106 from the smallest sprocket 131 to the largest sprocket 137 sequentially provide gradually smaller gear ratios (drive sprocket speed to cogset speed). Accordingly, the smallest sprocket 131 corresponds to the highest bike gear and the largest sprocket 137 corresponds to the lowest bike gear.

The flexible drive member 106 wraps around and engages the drive sprocket 102, the cogset 104 and a sprocket 109 of the derailleur 108. The flexible drive member 106 transmits torque from the drive sprocket 102 to a selected one of the sprockets 131, 132, 133, 134, 135, 136, 137 of the cogset 104. In the present embodiment, the flexible drive member 106 is a chain 106, the drive sprocket 102 is a chain sprocket, and the sprockets 131, 132, 133, 134, 135, 136, 137 of the cogset 104 are chain sprockets. It is contemplated that in other embodiments, the flexible drive member 106 could be a toothed drive belt, the drive sprocket 102 could be a belt sprocket, and the sprockets 131, 132, 133, 134, 135, 136, 137 of the cogset 104 could be belt sprockets.

The derailleur 108 is operatively connected to the shifter 32. In the present embodiment, the derailleur 108 is connected to the shifter 32 via tension cables (not shown). A shifting motor (not shown) is communicatively connected to the shifter 32 and is operatively connected to the tension cables. In response to a signal from the shifter 32, the shifting motor is configured to pull or release on the tension cables. In other embodiments, the derailleur 108 may be electronically connected to the shifter 32. In such embodiments, the derailleur 108 may be provided with a derailleur motor communicatively connected to the shifter 32. The derailleur 108 is also operatively connected to the chain 106. More specifically, the derailleur 108 includes the sprocket 109, which is engaged to the chain 106. In response to the shifter 32 being actuated, a position of the sprocket 109 is shifted. The sprocket 109 is moveable between seven positions, each one of the seven positions being generally laterally aligned with one of the sprockets 131, 132, 133, 134, 135, 136, 137 of the cogset 104.

In response to the position of the sprocket 109 being shifted, a lateral force is applied to the chain 106, which induces the chain 106 to move from the one of the sprockets 131, 132, 133, 134, 135, 136, 137 that it currently engages toward the sprocket 131, 132, 133, 134, 135, 136, 137 corresponding to the one that is laterally aligned with the position of the sprocket 109. For the chain 106 to successfully move between the sprockets 131, 132, 133, 134, 135, 136, 137 (i.e., for gear shifting to occur), the chain 106 and the cogset 104 have to be in motion. Thus, the lateral force applied on the chain 106 by the derailleur 108, while the chain 106 is in motion, causes the chain to be “derailed” onto the one of the sprockets 131, 132, 133, 134, 135, 136, 137 that is laterally aligned with the position of the sprocket 109.

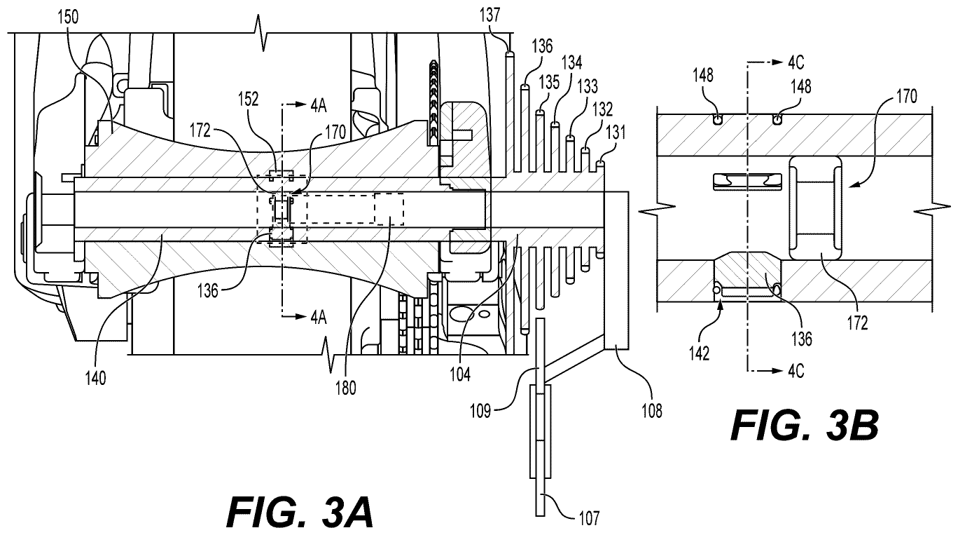

Referring to FIG. 3A, as mentioned above, the cogset 104 is operatively connected to the rear wheel 50. More specifically, the cogset 104 is connected a shaft 140 of the rear wheel 50, where the shaft 140 is received in a hollow hub 150 of the rear wheel 50.

At a lateral center thereof, the shaft 140 defines three apertures 142. The three apertures 142 are equally angularly spaced from one another (i.e., at 120 degrees from each other about a center axis of the shaft 140). For each aperture 142, the shaft 140 defines a recess 144. Each recess 144 extends circumferentially on either lateral side of the aperture 142. It is contemplated that in some embodiments, the apertures 142 and the recesses 144 may be offset from a lateral center of the shaft 140.

Each aperture 142 and its corresponding recess 144 receives a pawl 146. The pawls 146 may be referred to as cam followers. As will be described below, each one of the pawls 146 is moveable between a deployed configuration and a retracted configuration. In the deployed configuration, the pawls 146 extend at least partially out of their corresponding recess 144, and are moveable between a driving position and a non-driving position. In the retracted configuration, the pawls 146 are generally received within their corresponding recess 144.

Two spring rings 148 (FIG. 3B) are connected to each one of the pawls 146. More specifically, the spring rings 148 pass around the shaft 140 and over the pawls 146. The spring rings 148 bias the pawls 146 toward the retracted configuration. It is contemplated that the pawls 146 could be biased toward the retracted configuration differently. It is also contemplated that in some embodiments, there could be a single spring ring 148.

The hollow hub 150 has an engaging section 152 on an internal side thereof. The engaging section 152 is positioned so as to be engageable with the pawls 146 when the pawls 146 are in their deployed configuration. Thus, the engaging section 152 is generally laterally centered on the hollow hub 150. The engaging section 152 has teeth defined therein via which the hollow hub 150 is configured to be drivingly engaged by the pawls 146.

Referring back to the cogset 104, the cogset 104 is rotationally fixed to the shaft 140, such that in response to the cogset 104 rotating, the shaft 140 also rotates, and vice-versa. It is contemplated that in other embodiments, the cogset 104 and the shaft 140 could be connected differently. For example, in some embodiments, the cogset 104 and the shaft 140 could be connected by a one-way freewheel clutch, such that the shaft 140 would only rotate with the cogset 104 when the cogset 104 rotates in a given direction relative to the shaft 140.

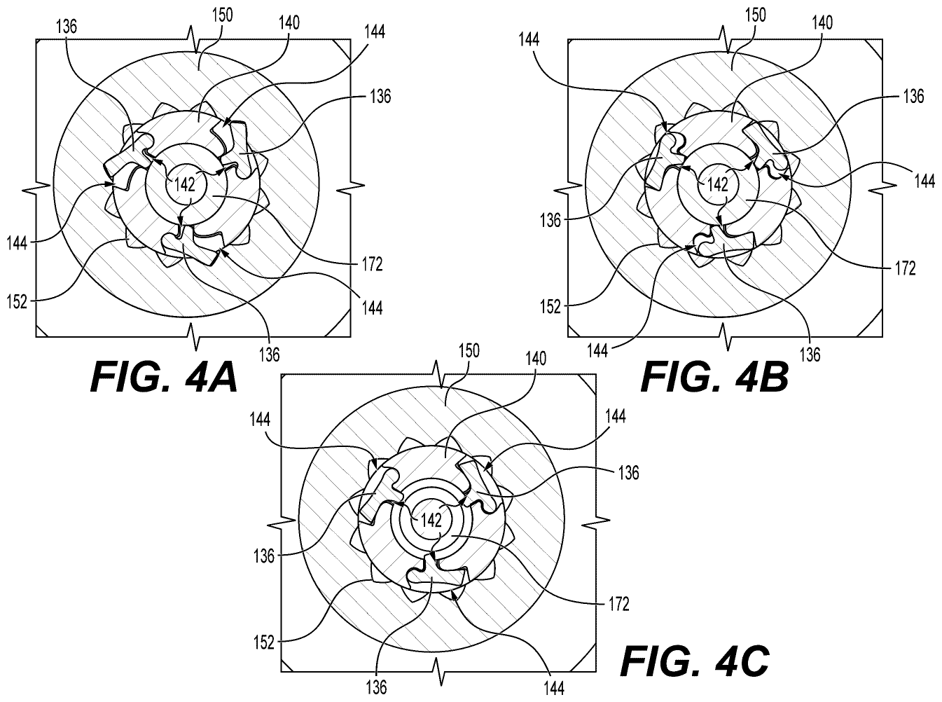

A clutch 170 is disposed in the shaft 140 and is moveable between an engaged state (FIGS. 3A, 4A and 4B), and a disengaged state (FIGS. 3B and 4C). As will be described below, when the clutch 170 is in the engaged state, the clutch 170 drivingly engages the cogset 104 to the rear wheel 50 (provided that the hollow hub 150 is not rotating faster than the shaft 140), whereas when the clutch 170 is in the disengaged state, the clutch 170 drivingly disengages the cogset 104 from the rear wheel 50.

The clutch 170 includes a cam 172 that is received in the shaft 140. The cam 172 is moveable within the shaft 140 between an engaged position (FIG. 3A) and a disengaged position (FIG. 3B). In the present embodiment, the cam 172 moves within the shaft 140 in an axial direction. It is contemplated that the cam 172 could move differently. For example, it is contemplated that the cam 172 could rotate between the engaged position and the disengaged position. When the cam 172 is in the engaged position, the cam 172 is axially aligned with the apertures 142 and with the pawls 146 of the shaft 140. In this position, the cam 172 abuts the pawls 146, and causes the pawls 146 to move to the deployed configuration. When the cam 172 is in the disengaged position, the cam 172 is axially offset from the apertures 142 and from the pawls 146 of the shaft 140, and the spring rings 148 bias the shift pawls 430 radially inward toward the retracted configuration. Other types of clutches 170 are contemplated. For example, in some embodiments, the clutch 170 could be a friction clutch.

The clutch 170 is operatively connected to a clutch actuator 180. More specifically, the cam 172 is operatively connected to the clutch actuator 180. In some embodiments, the clutch actuator 180 may be connected to the cam 172 via tension cables. The clutch actuator 180 is selectively actuatable for moving the cam 172 between the engaged and disengaged positions. The clutch actuator 180 is also communicatively connected to the controller 124.

Generally, when the pedelec 10 is in a default configuration, the clutch 170 is in the engaged state, such that the cam 172 is in the engaged position, and the pawls 146 are in the deployed configuration.

As such, referring to FIG. 4A, when the cogset 104 is driven by the crank arms 110 and/or the electric motor 120, the shaft 140 rotates. The pawls 146 which are in the deployed configuration and in the driving position, engage the teeth of the engaging section 152 of the hollow hub 50 for causing the rear wheel 50 to rotate, and thereby propel the pedelec 10 forward.

Referring to FIG. 4B, when the rear wheel 50 rotates faster than the cogset 104, the pawls 146, which are still in the deployed configuration, are moved to their non-driving position by the engaging section 152. Thus, when the rear wheel 50 (and thus the hollow hub 150) rotates faster than the shaft 140 (and thus the cogset 104) the pawls 146 are not drivingly engaged to the engaging section 152.

Referring to FIG. 4C, the clutch 170 is moved to the disengaged state, in which the cam 172 is in the disengaged position, and the pawls 146 are in the retracted configuration. When the pawls 146 are in the retracted configuration, the pawls 146 are generally received in their respective recesses 144, and do not engage with the engaging section 152. Therefore, rotation of the cogset 104 is not transmitted to the rear wheel 50 (i.e., rotating the cogset 104 does not result in the pedelec 10 being propelled forward).

The present technology enables the cyclist to shift gears on the pedelec 10 in different ways and in different scenarios. In one instance, gear shifting may occur with the pedelec 10 moving in a forward direction, the crank arms 110 being turned by the cyclist, and the clutch 170 being in the engaged state or in the disengaged state. In another instance, gear shifting may occur with the pedelec 10 moving in a forward direction, the electric motor 120 being actuated, and the clutch 170 being in the engaged state or in the disengaged state. In another instances, as will be described in greater detail below, gear shifting may also occur with the pedelec 10 being at a standstill, the crank arms 110 being turned and/or the electric motor 120 being actuated, and the clutch being in the disengaged state. That is, the present technology enables gear shifting without having to propel the pedelec 10 forward.

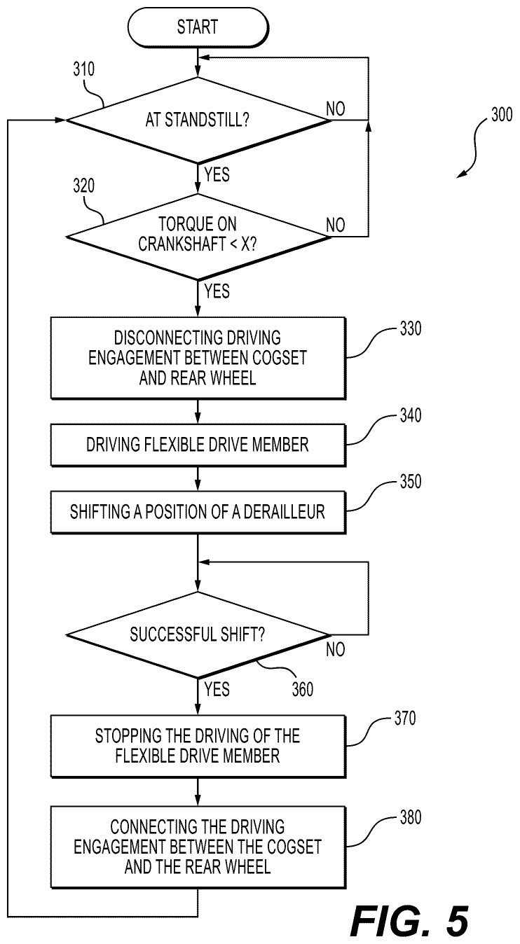

With reference to FIG. 5, a method 300 for controlling gear shifting of the pedelec 10 that is at a standstill will now be described. The method 300 may be performed to reduce effort of the cyclist and/or strain of the electric motor 106 to get the pedelec 10 moving from the standstill position. As will become apparent from the below, it is contemplated that the present technology can provide a method for controlling gear shifting of the pedelec 10 without having to propel the pedelec 10 forward. While the method 300 is described with reference to the pedelec 10, it is contemplated that the method 300 could be performed with bicycles not having an electric motor. Additionally, while the method 300 is described as being performed by the controller 124, it is contemplated that the method 300 may be performed, in part or in whole, by the cyclist.

For the method 300 to begin, the controller 124 must be in an operating state. For example, the controller 124 could move into the operating state after a few rotations of the crank arms 110, a few rotation of one of the wheels 40, 50, or in response to the actuation of the shifter 32, the brake lever 30 or a dedicated “ON” button.

At step 310, the controller 124 determines whether the pedelec 10 is at a standstill. The controller 124 can determine whether the pedelec 10 is at a standstill via information sensed by one of the sensors 126, for example, by the linear speed sensor and/or by the rotational speed sensors.

In some embodiments, after determining whether the pedelec 10 is at a standstill, the controller 124 may determine which one of the sprockets 131, 132, 133, 134, 135, 136, 137 the chain 106 is engaged to. The controller 124 can determine which one of the sprockets 131, 132, 133, 134, 135, 136, 137 the chain is engaged to via one of the sensors 126, for example, by a sensor sensing the derailleur position 109. If the chain 106 is in engagement with the sprocket 137, the controller 124 can return to the beginning of the method 300, because the effort required by the cyclist and/or the strain of the electric motor 120 to get the pedelec 10 moving would already be at a minimum.

If at step 310, the controller 124 determines that pedelec 10 is not at a standstill, then the controller 124 returns at the beginning of the method 300.

If at step 310, the controller 124 determines that the pedelec 10 is at a standstill, then the controller 124 proceeds to step 320.

At step 320, the controller 124 determines whether a torque applied to the crank arms 110 is less than or equal to a predetermined value. In some embodiments, the predetermined value is zero. The controller 124 can determine whether a torque is applied to the crank arms 110 via one of the sensors 126, for example via the torque sensor.

If at step 320, the controller 124 determines that the torque applied to the crank arms 110 is greater than or equal to the predetermined value, then the controller 124 returns at beginning of the method 300.

If at step 320, the controller 124 determines that the torque applied to the crank arms 110 is less than the predetermined value, then the controller 124 proceeds to step 330.

It is contemplated that in some embodiments, the step 320 could be omitted.

At step 330, the controller 124 causes the disconnection of the driving engagement between the cogset 104 and the rear wheel 50 by sending a signal to the clutch actuator 180 to move the clutch 170 to the disengaged state. More specifically, in response to the signal from the controller 124, the clutch actuator 180 moves the cam 172 to the disengaged position, which in turn results in the pawls 146 moving to their retracted configuration, resulting in drivingly disconnecting the shaft 140 from the hollow hub 150. At this stage, driving the drive sprocket 102, and thus rotating the cogset 104, does not result in the pedelec 10 being propelled forward.

The controller 124 then proceeds to step 340.

At step 340, the chain 106 is driven. More specifically, the controller 124 sends a signal to the electric motor 120 to drive the drive sprocket 102, which in turn drives the chain 106.

In some instances, such as for a bicycle without an electric motor, driving the chain 106 may be accomplished by rotating the crank arms 110. This can be achieved by displaying a message on a display or emitting a sound from a speaker prompting the cyclist to turn the pedals 112. As no torque is transferred to the rear wheel 50 by turning the pedals 112, this can be achieved by the cyclist pedaling with one foot on one pedal while the other foot is on the ground since the bicycle is stopped.

The controller 124 then proceeds to step 350.

At step 350, the controller 124 causes the shifting of the position of the derailleur 108 by sending a signal to the shifter 32. More specifically, in response to the signal from the controller 124, the position of the sprocket 109 of the derailleur 108 is shifted. In some implementations of the method 300, at step 350, the position of the sprocket 109 is shifted so as to be laterally aligned with the sprocket 137 of the cogset 104 (in order to put the pedelec 10 in the lowest gear).

Performing step 350 after step 340 can assist in reducing wear on the chain 106 and the derailleur 108 by limiting strain on the chain 106 and the derailleur 108. However, it is contemplated that the step 350 may be performed before step 340.

The controller 124 then proceeds to step 360.

At step 360, the controller 124 determines whether the chain 106 has successfully shifted from one of the sprockets 131, 132, 133, 134, 135, 136 to the sprocket 137. The controller 124 can determine whether the chain 106 has successfully shifted by comparing the rotational velocity of the cogset 104 (measured via one of the rotational sensors 126) with the rotational velocity of the drive sprocket 102 (measured via one of the sensors 126). In other embodiments, the controller 124 can determine whether the chain 106 has successfully shifted via one of the sensors 126 that can provide an absolute position of the derailleur and/or the chain 106.

If at step 360, the controller 124 determines that the chain 106 has not successfully shifted gears, the motor 120 continues to drive the sprocket 102 and the controller 124 returns to step 360.

If at step 360, the controller 124 determines that the chain 106 has successfully shifted gears, the controller 124 proceeds to step 370.

In other embodiments, the step 360 could be omitted, and the controller 124 could proceed from step 350 to step 370 after a predetermined amount of time has elapsed since step 340 or 350 has been initiated or after a predetermined number of rotations of the drive sprocket 102 and/or the cogset 104 since step 340 or 350 has been initiated.

At step 370, driving of the chain 106 is stopped. More specifically, the controller 124 sends a signal to the electric motor 120 to stop driving the drive sprocket 102, which in turn stops the driving of the chain 106.

The controller 124 then proceeds to step 380.

At step 380, the controller 124 causes the connection of the driving engagement between the cogset 104 and the rear wheel 50 by sending a signal to the clutch actuator 180 to move the clutch 170 to the engaged state. More specifically, in response to the signal from the controller 124, the clutch actuator 180 moves the cam 172 to the engaged position, which in turn results in the pawls 146 moving to their deployed configuration, resulting in drivingly connecting the shaft 140 to the hollow hub 150. At this stage, driving the drive sprocket 102, with the motor 120 or the crank arms 110, results in propelling the pedelec 10 forward. Since the chain 106 is in engagement with the sprocket 137 (i.e., in the lowest gear), the pedelec 10 requires less effort from the cyclist and/or less strain on the electric motor 120 for getting the pedelec 10 moving.

The controller 124 then returns to step 310.

It is contemplated that at least some steps of the method 300 could be performed in varying order. For example, step 320 may be performed before step 310, and step 350 may be performed before step 340.

It is contemplated that in some embodiments of the method 300, the step 310 could be omitted. In such embodiments, the clutch 170 could be disengaged to shift gears while the pedelec 10 is moving at a constant speed (e.g., cruising) or while the pedelec 10 is accelerating without actively driving the drive wheel 102 (e.g., going downhill). In such embodiments, the position of the sprocket 109 of the derailleur 108 would be laterally aligned with any one of the sprockets 131, 132, 133, 134, 135, 136, 137, as the cyclist may not necessarily want to shift to the low gear. Additionally, in such embodiments, the step 270 of stopping the driving of the chain 106 may be omitted (i.e., driving of the drive member 102 is not stopped after successful shifting.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A method for controlling gear shifting of a bicycle, the method comprising:
disconnecting a driving engagement between a cogset of the bicycle and a rear wheel of the bicycle;
driving a flexible drive member, the flexible drive member engaging the cogset and a drive sprocket of the bicycle;
shifting a position of a derailleur of the bicycle for causing the flexible drive member to shift from one driven sprocket of the cogset to an other driven sprocket of the cogset; and
after shifting the flexible drive member from the one driven sprocket of the cogset to the other driven sprocket of the cogset, connecting the driving engagement between the cogset and the rear wheel.

2. The method of claim 1, further comprising that the bicycle is at a standstill prior to disconnecting the driving engagement.

3. The method of claim 1, wherein shifting the position of the derailleur is performed after driving the flexible member.

4. The method of claim 1, wherein:
disconnecting the driving engagement between the cogset and the rear wheel includes moving a clutch to a disengaged state, the clutch selectively coupling the cogset to the rear wheel; and
connecting the driving engagement between the cogset and the rear wheel includes moving the clutch to an engaged state.

5. The method of claim 1, wherein:
disconnecting the driving engagement between the cogset and the rear wheel includes moving at least one pawl of a shaft of the rear wheel from a deployed configuration to a retracted configuration; and
connecting the driving engagement between the cogset and the rear wheel includes moving the at least one pawl of the shaft of the rear wheel from the retracted configuration to the deployed configuration.

6. The method of claim 5, wherein moving the at least one pawl between the deployed configuration and the retracted configuration includes moving a cam between:
a first position, in which the cam is engaged and aligned with the at least one pawl, causing the at least one pawl to be in the deployed configuration, and
a second position, in which the cam is disengaged and spaced from the at least one pawl, causing the at least one pawl to be in the retracted configuration.

7. The method of claim 1, wherein disconnecting the driving engagement between the cogset and the rear wheel includes actuating a clutch actuator.

8. The method of claim 1, further including, before connecting the driving engagement between the cogset and the rear wheel, determining that the flexible drive member has shifted from the one driven sprocket of the cogset to the other driven sprocket of the cogset.

9. The method of claim 8, wherein determining that the flexible drive member has shifted from the one driven sprocket of the cogset to the other driven sprocket of the cogset is determined via sensors.

10. The method of claim 1, further comprising, after shifting the flexible drive member from the one driven sprocket of the cogset to the other driven sprocket of the cogset, and before connecting the driving engagement between the cogset and the rear wheel, stopping the driving of the flexible drive member.

11. The method of claim 10, wherein stopping the driving of the flexible drive member occurs after one of:
a predetermined elapsed time after shifting the position of the derailleur; and
a predetermined number of rotations of the drive sprocket after shifting the position of the derailleur.

12. The method of claim 1, wherein driving the flexible drive member includes actuating a motor operatively connected to the drive sprocket.

13. The method of claim 1, further comprising:
detecting a torque applied on a pedal of the bicycle, and
in response to the detected torque being greater than a predetermined value, preventing the disconnecting of the driving engagement between the cogset and the rear wheel.

14. The method of claim 1, wherein driving the flexible drive member includes turning pedals of the bicycle, the pedals being drivingly engaged to the drive sprocket.

15. A bicycle comprising:
a frame;
a handlebar operatively connected to the frame;
a front wheel operatively connected to the handlebar;
a rear wheel operatively connected to the frame; and
a drive assembly connected to the frame, the drive assembly including:
a drive sprocket;
crank arms operatively connected to the drive sprocket;
a cogset operatively connected to the rear wheel;
a clutch operatively connected between the cogset and the rear wheel, the clutch being movable between:
an engaged state, in which the clutch drivingly engages the cogset to the rear wheel; and
a disengaged state, in which the clutch drivingly disengages the cogset from the rear wheel,
a clutch actuator operatively connected to the clutch, the clutch actuator being selectively actuated for moving the clutch between the engaged state and the disengaged state;
a flexible driving member engaging the drive sprocket and the cogset; and
a derailleur operatively connected to the flexible driving member.

16. The bicycle of claim 15, further comprising:
an electric motor operatively connected to the drive sprocket; and
a battery pack connected to the frame and electrically connected to the electric motor.

17. The bicycle of claim 15, wherein:
the rear wheel includes:
a hollow hub;
a shaft received in the hollow hub, the shaft being operatively connected to the cogset, and having at least one pawl moveable between:
a deployed configuration, in which the shaft is drivingly engaged with the hollow hub; and
a retracted configuration, in which the shaft is drivingly disengaged from the hollow hub,
the clutch includes a cam moveable between a first position and a second position, and
with the clutch in the engaged state, the cam is in the first position, in which the cam is engaged with the at least one pawl, causing the at least one pawl to be in the deployed configuration; and
with the clutch in the disengaged state, the cam is in the second position, in which the cam is disengaged from the at least one pawl, causing the at least one pawl to be in the retracted configuration.

18. The bicycle of claim 15, wherein the flexible driving member is a chain.

19. The bicycle of claim 15, further comprising a controller in communication with the clutch actuator and the derailleur, the controller being configured to:
cause actuation of the clutch actuator for moving the clutch to the disengaged state;
cause a shift of the position of the derailleur for causing the flexible drive member to shift from one driven sprocket of the cogset to an other driven sprocket of the cogset; and
after causing the shift of the position of the derailleur, cause actuation of the clutch actuator for moving the clutch to the engaged state.

20. The bicycle of claim 15, wherein the first position is a first axial position and the second position is a second axial position.
